(19) United States
(12) Patent Application Publication
(10) Pub. No.: US 2015/0079947 A1
(43) Pub. Date: Mar. 19, 2015

(54) Emotion Express EMEX System and Method for Creating and Distributing Feelings Messages

(71) Applicant: David Evgey, Pikesville, MD (US)

(72) Inventor: David Evgey, Pikesville, MD (US)

(21) Appl. No.: 14/029,967

(22) Filed: Sep. 18, 2013

(51) Int. Cl. H04W 4/12; H04M 1/725; G06F 17/30

(52) U.S. Cl. CPC H04W 4/12; G06F 17/30752; H04M 1/7255; H04M 1/72558
USPC 455/413

(57) ABSTRACT

Disclosed is a system and method for creating and distributing customized messages using a mobile communication device. The system comprises a mobile application, which retrieves a desired music file from a music files repository based on relationships for creating customized messages. A user can add a personalized voice message to at least one designated part of the at least one music file retrieved from a music files repository. The music file is a professionally recorded song by artists agreeing to unlimited duplication of the professionally recorded songs for the purpose of exposure and/or advertising of own skills. Each of the professionally recorded songs includes at least 20 to 30 seconds background music section where the user records the at least one personalized voice message. A content distribution network associated with the mobile communication device send the customized messages to a plurality of recipients selected by the user.

### BACKGROUND

The present invention relates to a method and system for creating and distributing customized message, expressing feelings, using mobile communication devices, more particularly to a method and system for creating and distributing personalized voice messages, an audio file, which consists of pre recorded music mixed with a personalized message.

Earlier mobile communication device employed short messaging service based on second-generation (2G) mobile communication to share information. The development of the third-generation (3G) mobile communication system eliminated the network bandwidth and the intrinsic disadvantages of Short Message Service as it has a wider field than that based on the 2G mobile communication system. Multimedia technology enables people to represent and transmit messages more accurately and emotionally. The MMS provides a multimedia communication mode, in which a user can send or receive a multimedia message consisting of texts, images, videos and audios. With the advancement in communication with fourth generation (4G) technology, it became cheap and easier to share the multimedia content through various means including wireless LAN (WLAN).

Mobile to mobile messaging service such as multimedia messaging, content sharing etc. are a popular mode of communication to share information. For expressing emotion to a particular person or a particular event, a person sends a personalized message to his or her loved one. The personalized message may be personalized multimedia contents including specific songs, pictures, video contents etc. These personalized multimedia contents are selected by the user or by using an application, which selects and send the customized massage to his or her loved one. These messages are send with specialized contents and the goal in mind is to create a feeling of a particular event, place, occasion etc. with the recipient. By this way, an emotion felt by one individual toward another can be shared between two or more individuals. Existing systems incorporates expressing an emotion with a song, which is selected by the user and shared with at least one person selected by the user. In some cases, the song lyrics are crafted to describe a human emotion, event etc. in a precise manner. The background music with the song lyric intensifies the description.

Existing systems and methods expresses the emotion to a particular person or addressing a particular event by sending a recording of the song encapsulating the emotion that may or may not adequately convey specific feelings and/or address specific events. In these systems the user have to select a particular music or song lyric from a pool of songs, which makes the process even more difficult. A limited number of services are available in market that provides limited number of songs selected from various public Internet sites and relating to particular emotion or set of feelings, often with poor audio quality. Some other systems allows the users to edit the audio by adding external audio, video and picture contents suited for the particular person or event. However, these editing may be done by inserting the clips or picture on an unnoticed portion of the music. In some cases, the personalized message cannot be conveyed effectively with the absence of supporting music needed to create the ambiance associated with a particular emotional situation.

Thus, there exists a need for a service that can provide access to licensed audio that allows for the editing of audio file with personal and customized by the user accurately addressing customized and specific contents, ensuring at the same time that sender and recipient/s associated with these transactions are not in violation of copyright laws. In addition, the needed method would provide users with a way to find the specific feeling they are looking to express from within the music so that they can associate the personalized content with the music effectively. Further, the needed system would provide exposure to an artist and would enable them to advertise their skills as singers or musicians.

### SUMMARY

EMEX, the present invention comprises a system and method for creating and distributing customized messages combining music, the language of emotions, and a personalized user-generated voice message in the mobile communication device. The process consists of three stages. First stages the user performs a search based on keywords such as “Mother” or “Girl friend” to select the type of the person to which the message will be sent to or “get well” to describe an event or subject, as well as “Hebrew” or “Spanish” to select a language. Second stage after selecting the song is to record, when prompted by EMEX, a personalized audio message, EMEX mixes the personalized audio message with professionally recorded music and or/song and creates an audio file, Third stage EMEX sends the file to a recipient or a group. All songs can be shared with a recipients or a group without the user paying any royalties or breaching any third party copyright. The system comprises a mobile application running on the mobile communication device. The user can access the mobile application to select and retrieve a desired music file from a music files library of songs in various subjects for creating customized messages. The music file may be stored in a physical memory of the mobile communication device or in a remote media server. The user can record at least one personalized voice message by launching the feature from the user interface of the mobile application. The user interface of the mobile application includes an option to add the personalized voice message to at least one designated part of the at least one music file retrieved from a music files repository. The music file retrieved from the music files repository is a professionally recorded song by artists agreeing to unlimited duplication of the professionally recorded songs for the purpose of exposure and/or advertising of own skills. Each of the professionally recorded songs includes at least 20 to 30 seconds background music section where the user records the at least one personalized voice message. A database associated with the mobile application stores the at least one personalized voice message which is added, at least in part, to the at least one designated part of the at least one music file. A content distribution network associated with the mobile communication device sends the customized messages, which consists the music mixed with user recorded verbal message to a plurality of recipients selected by the user.

When the recipients listen to the customized messages received on their mobile communication devices generates a process where the person thinks about the subject, and by the way of association, one thought leads to another creating in the process the desired feeling. Thus, the success or failure of the song with the customized messages depends entirely on its ability to create the needed emotion with the end users or recipients. These customized messages created by using the mobile application is the best and most memorable way to deliver the users message to his or her loved one and a pleasant way to listen to the song/message again and again giving the message meaningful power and significance.

Other objects and advantages of the embodiments herein will become readily apparent from the following detailed description taken in conjunction with the accompanying drawings.

### BRIEF DESCRIPTIONS OF THE DRAWINGS

FIG. 1 is a block diagram of a system for creating and distributing customized messages in a mobile communication device according to an embodiment of the present invention.

FIG. 2 is a flowchart illustrating a method of creating and distributing customized messages in a mobile communication device according to an embodiment of the present invention.

FIG. 3 is a screenshot of the mobile application running in the mobile communication device according to an embodiment of the present invention.

### FIGURES

### Reference Numerals

100—System
102—Mobile Communication Device
104—Mobile Application
106—Storage
108—Music files repository
110—Personalized voice message
112—Customized messages
114—Content Distribution Network
116, 118, 120—End User
122—Remote Media Server

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The present invention is a system and method for creating and distributing customized messages in a mobile communication device. The mobile communication device is in communication with a music repository to create and deliver customized messages to at least one recipient.

The mobile communication devices include a variety of devices, including but not limited to cellular phones, smart phones, PDA's, laptops, tablet computers, and other portable electronic devices that include voice and data cellular network service. The cellular network includes third and fourth generation mobile networks which enables the web access to consumer downloadable applications from an application store. The present invention is preferably platform and device independent, and in some cases, the mobile application is modified to run smoothly on specific devices having different hardware and software configurations. The mobile communication devices may run a variety of operating systems including Microsoft Windows Mobile, Microsoft Windows Phone 7 and 8, RIM Blackberry OS, Apple iOS, Android OS, Symbian, Java, Linux, or any other technology platform. For purposes of this disclosure, the present invention has been generally described in accordance with features and interfaces that are optimized for a smartphone utilizing a generalized platform, although one skilled in the art would understand that all such features and interfaces may also be used and adapted for any other platform and/or device. Although the specification may focus on the mobile communication device being a smartphone, it should be understood by those of ordinary skill in the art having the present specification, drawings, and claims before them that this is simply for ease of explanation and not intended to limit the present invention to any smartphone embodiment.

The mobile communication devices may include a microphone to record the personalized message, an audio speaker to read out or play the customized message, a graphical display for displaying the messages, and a keypad, keyboard, pointing device and/or a touch screen. The mobile communication devices will also include a processor and memory. The memory may include ROM or the physical memory to store the music files created by an artist, RAM or the volatile memory to temporarily store the files during editing and processing as well as one or more removable memory cards. The ROM stores the installed mobile application, the processor and the RAM runs the application over an operating system of the mobile communication device. The communication device such as a SIM card, stores the details of the intended recipients of the customized message in addition to the contact stored in the memory of the mobile communication device.

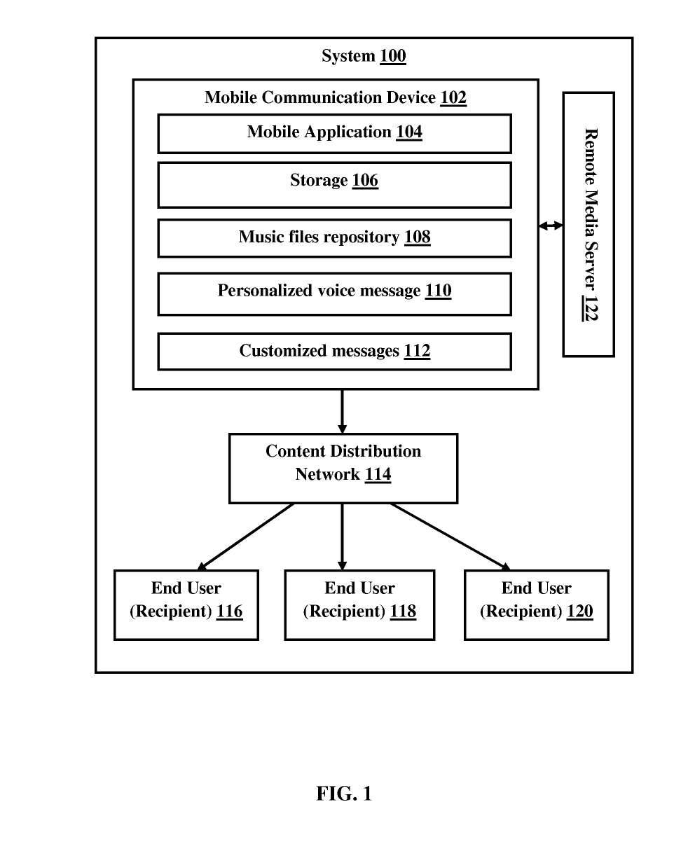

FIG. 1 illustrates a block diagram of the system 100 for creating and distributing customized messages in the mobile communication device 102 according to an embodiment of the present invention. The system 100 and associated unique method perform the creation and distribution of customized messages 112. These customized messages 112 includes a personalized voice message 110 from a user combined with at least one music file at designated parts of the music. The system 100 comprises a mobile application 104 running on the mobile communication device 102. The user can access the mobile application 104 to select and retrieve a desired music file from a music files repository 108 for creating customized messages. The music file may be stored in a physical memory of the mobile communication device 102 or in a remote media server 122. The music files repository 108 accessible from a user interface of the mobile application 104 enables the user to select desired music file stored from the physical memory of the mobile communication device 102 and/or from the remote media server 122. The user can record at least one personalized voice message by launching the feature from the user interface of the mobile application 104. The user interface of the mobile application 104 includes an option to add the personalized voice message to at least one designated part of the at least one music file retrieved from the music files repository 108. The music file retrieved from the music files repository 108 is a professionally recorded song by an artist. For using these music file the artists should agree to unlimited duplication of the professionally recorded songs for the purpose of exposure and/or advertising of own skills. This helps the users and providers associated with these transactions to be not included in a violation of copyright laws. Each of the professionally recorded songs includes at least 20 to 30 seconds background music section where the user records the at least one personalized voice message 110. A database associated with the mobile application 104 stores the at least one personalized voice message 110 which is added, at least in part, to the at least one designated part of the at least one music file. The resulting customized messages 112 are particularly created for expressing emotions. The customized messages 112 can be stored in the physical memory or storage 106 of the mobile communication device 102 from within the mobile application 104. The mobile application 104 also provides options to save the customized messages 112 created by the user for a particular event or to a particular person or a group of persons in a remote media server 122. The mobile application 104 accesses the remote media server 122 through the mobile communication device's 102 data connection or through a variety of communication means including wireless local area network (WLAN), infrared, Bluetooth, wired communication etc. The user can distribute or send the customized messages 112 from within the user interface of the mobile application 104. A content distribution network 114 associated with the mobile communication device 102 send the customized messages 112 to a plurality of recipients 116, 118 and 120 selected by the user. The customized messages 112 are distributed to a plurality of mobile communication devices of the plurality of recipients through a communication means selected from wireless local area network (WLAN), wide area network (WAN), LAN, Wi-Fi, or other computer network, infrared, Bluetooth, email, third and fourth generation mobile data communication, near field communication (NFC) etc.

When the recipients 116, 118 and 120 listens to the customized messages 112 received on their mobile communication devices generates a process where the person thinks about the subject and by the way of association one thought leads to another creating in the process the desired feeling. Thus, the success or failure of the song with the customized messages 112 depends entirely on its ability to create the needed emotion with the end users or recipients 116, 118 and 120. These customized messages 112 created by using the mobile application 104 is the best and most memorable way to deliver the users message to his or her loved one. Each of the mobile communication devices 102 includes individual user interfaces based on the operating system that enables the end users 116, 118 and 120 to receive the customized messages 112 and to respond to the received messages.

In an embodiment of the present invention, the user interface of the mobile application 104 enables the user to select desired music file from a plurality of music directories available in the internet. The desired music file selected by the user from the internet resources can be stored within the physical storage 106 of the mobile communication device 102 or on the remote media server 122. All these operations can be done from within the options in the user interface of the mobile application 104. The criteria for selecting the desired music file from the internet resources are that the song that is professionally recorded with an artist, preferably an artist who is looking for exposure. The artists who agree to unlimited duplication of songs can upload a plurality of music files to the music files repository 108. These songs are stored in the remote media server 122. While sharing the customized message 112 to the plurality of end users 116, 118 and 120, the artists or singers get the needed exposure or advertising of their skills as singers or musicians.

In another embodiment of the present invention, the mobile application 104 enables the users to insert more than one personalized contents including personalized voice messages 110 with the music files or the professionally recorded song by the artist to create the customized message 112. The user interface of the mobile application is configured to insert both previously recorded personalized voice messages 110 and live recordings with designated areas of the music file. The designated areas of the music file created by the artist contain only a background music, which helps to elevate the emotions of the end users or the recipients 116, 118 and 120, when added with the personalized voice messages 110. In an embodiment, the music files created by the artists are sorted, grouped and stored in the storage 106 of the mobile communication device 102 or in the remote media server 122. The music files are grouped into a plurality of groups including family, love, friends, religion, mother, father, spouse and events including wedding, anniversary, receipt of love, birthday etc. Hence, the user by using the user interface of the mobile application 104 can easily search and find the most effective song for the particular occasion. The professionally recorded song by the artists or pre-existing recordings may send audio files in a variety of formats including but not limited to mp3, way, m4a, wma, mpeg to the mobile application 104. The mobile application 104 running on the mobile communication device 102 is capable of converting the different formats of the audio files to enable the customized message to be readable in most of the recipient's mobile devices.

The music files repository 108 acts as a temporary storage or database for the music files selected from the physical storage 106 of the mobile communication device 102 or from the remote media server 122. The music files on the physical storage location 106 on the mobile communication device 102 or the remote media server 122 stores the plurality of music files in predetermined formats. Thus, the edited personalized voice messages 110 with the customized message 112 sent is in a format readily played by the plurality of devices of the recipients or the end users 116, 118 and 120. The mobile application 104 can be installed and run on a variety of mobile operating systems including Android, iOS, Blackberry OS and Windows phone OS. The music files repository 108 is accessible through the user interface of the mobile application 104 running on the mobile communication device 102 and can be accessed external to the application to create and deliver the customized messages 112 based on mood, relationship of the plurality of users and/or specialized events. In one embodiment, the mobile application 104 running on the mobile communication device 102 enables the user to select more than one music file from the music files repository 108 through the user interface of the mobile application 104. Upon selection of the music files, the user can add different voice messages in the designated parts of the music files. The multiple customized messages 112 can be created easily by attaching different personalized voice messages 110 to different designated points of the music file. Multiple customized messages 112 can be send to different end users from within the user interface of the mobile application 104 quickly. While the storage 106 and remote media server 122 is shown as single units for storing the music file and the customized messages 112, it should be understood by those of ordinary skill in the art having the present specification, drawings, and claims that the music files and the customized messages 112 may be stored in multiple locations and across multiple pieces of hardware, including but not limited to storage in the cloud. In view of the sensitivity and/or commercial significance of most of the data stored in the databases or storages are preferably secured in an attempt to minimize the risk of undesired disclosure of the professionally recorded song file or audio by an artist. The databases may be standard relational database systems such as those available from Oracle, which are widely used to organize media files.

In another embodiment of the present invention, every personalized and customized messages 112 is recorded in the storage 106 of the mobile communication device 102 or the remote media server 122. The mobile application 104 may also allow the user to share the customized messages 112 via a variety of channels like social network, which includes Facebook, google plus, etc. directly from the user interface of the mobile application 104. This may even expand the reach of the personalized messages through various networks to be experienced by many, and thereby increasing the publicity of the artists and singers.

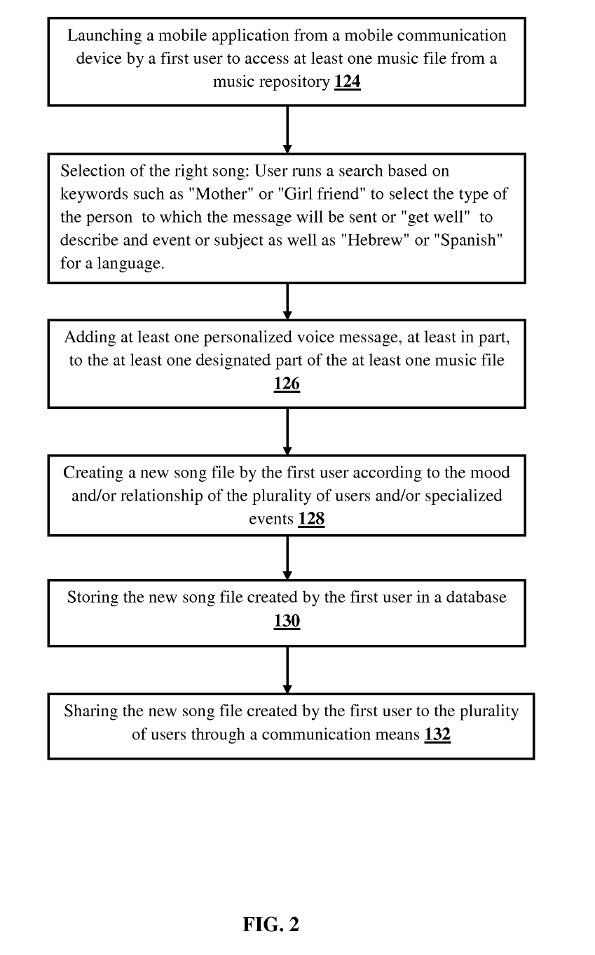

Referring to FIG. 2, a flowchart illustrating a method of creating and distributing customized messages 112 in the mobile communication device 102 according to an embodiment of the present invention is disclosed. The method starts with the step 124 of launching the mobile application 104 from the mobile communication device 102 by a first user to access at least one music file from the music files repository 108. After launching the mobile application, the at least one personalized voice message 110 is added, at least in part, to the at least one designated part of the at least one music file selected from the music files repository 108 as shown in block 126. The at least one personalized voice message 110 is selected based on mood, event and/or relationship of a plurality of users. Based on the mood, event and/or relationship, the user creates a new song file as shown in a succeeding step of block 128. Next, as in block 130, the new song file created by the user is stored in a database prior to distributing the new song file with customized messages 112 to the plurality of users through the content distribution network 114. This may be a temporary or a permanent storage on the physical memory of the mobile communication device 102 or on the remote music server 122 as decided by the user. Now the customized message 112 is shared with a plurality of end users selected by the user of the mobile application 104 as in block 132 to create a desired feeling with the recipient 116, 118 and 120. The communication means for sharing the customized message 112 is selected from various means including wireless local area network (WLAN), wide area network (WAN), LAN, Wi-Fi, or other computer network, infrared, Bluetooth, email, third and fourth generation mobile data communication, near field communication (NFC) etc. The customized message 112 includes a professionally recorded song by an artist. Each of the professionally recorded songs includes at least 20 to 30 seconds background music section where the user records the at least one personalized voice message 110. The artists should agree to unlimited duplication of the professionally recorded songs for the purpose of exposure and/or advertising of own skills through this application.

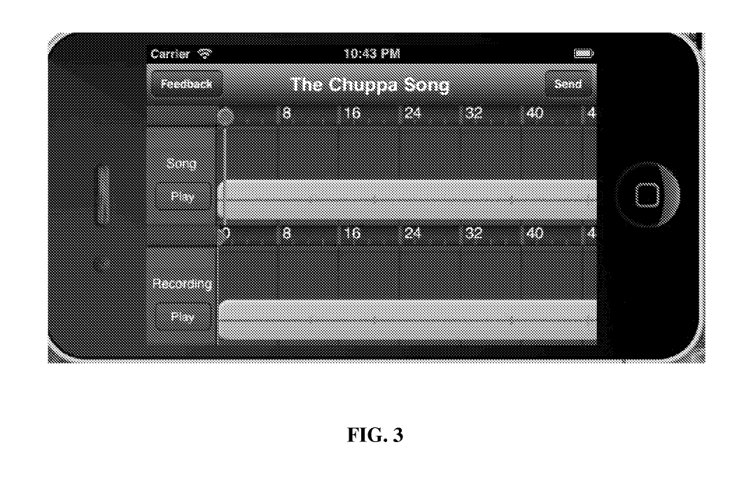

Referring to FIG. 3, a screenshot of the mobile application 104 running in the mobile communication device 102 according to an embodiment of the present invention is disclosed. The user can select the desired music file according to a relationship. The mobile application 104 categorizes the lists the songs according to events, moods, human relations, etc. The user can select the desired song from the user interface of the mobile application 104 running in the mobile communication device 102. The music files hence can be retrieved from the music files repository 108 and loaded onto a section of the user interface of the mobile application 104 running in the mobile communication device 102. A second section of the user interface of the mobile application 104 includes an option to add or record a particular personalized voice message 110 at the desired locations of the song file while playing. The user can add his/her own personalized voice message 110 according to events, moods, human relations, etc. After creating the customized message 112 the user can play the music directly from the user interface of the mobile application 104 running in the mobile communication device 102.

An example of the customized message 112 developed with the mobile application 104 includes a song file composed by an artist that may have the ability to create the needed emotion with the recipients. The song file is professionally recorded with an artist, preferably an artist who is looking for exposure, or an artist who is willing to unlimited duplication of the professionally recorded songs for the purpose of exposure and/or advertise his/her own skills and talent. During the song there are 20 to 30 seconds with background music where the user records a personalized voice message 110. The system having the mobile application 104 mixes the original track along with the message and create a new song file that the user can send to his friends or family without any limits. Thereby a new song file can be created by each user and he/she can share it with everyone. The songs includes subject such as love, religion, mother, father, family and etc. The present example includes the song recorded about a wedding and receipt for love, where family members can record a personalized message and send to bride and groom. Thereby the song can be used to deliver the customized messages through a desired musical format that may be the best and most memorable way to deliver the user's message. The created music file has the ability to create the needed emotion with the recipients of the customized messages with the song.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

We claim:

1. A system for creating and distributing a plurality of customized messages using a mobile communication device, the mobile communication device being in communication with a special royalty free music and songs files repository or library. This library of songs is classified by keywords describing a person such as “Mother”, a language such as “Spanish” or an event such as “Get well”, to create fully customized messages and deliver the plurality of customized messages to at least one recipient, the system comprising:
a mobile application running on the mobile communication device capable of accessing the music files repository to retrieve at least one music file, based or result of search describing relationship such as Mother and/or a language such as Spanish, the at least one music file being at least one professionally recorded song created by an artist, wherein the mobile application lists a plurality of songs in the music files repository based on a relationship with a user;
a content receiving means of the mobile application to receive at least one personalized voice message from the user, the at least one personalized voice message is being added, at least in part, to at least one designated part of the at least one music file retrieved from the music files repository;
a database associated with the mobile application to store the at least one personalized voice message added, at least in part, to at least one designated part of the at least one music file; and
a content distribution means accessible through the mobile application to distribute the plurality of customized messages to a plurality of mobile communication devices of a plurality of users.

2. The system of claim 1 wherein the at least one personalized voice message added, at least in part, to the at least one designated part of the at least one music file for creating the customized message.

3. The system of claim 1 wherein the music files library or repository includes a physical storage location on the mobile communication device and/or a remote media server for storing a plurality of music files in predetermined formats.

4. The system of claim 1 wherein the music files repository is accessible through a user interface of the mobile application running on the mobile communication device to create and deliver customized messages based on mood, relationship and/or specialized events of the plurality of users.

5. The system of claim 1 wherein the at least one music file is selected from the music files repository through the user interface of the mobile application for adding the at least one voice message in the at least one designated part of the music file.

6. The system of claim 1 wherein the at least one music file includes the at least one professionally recorded song created by the artist agreeing to unlimited duplication of the professionally recorded songs for the purpose of exposure and/or advertising of own skills.

7. The system of claim 1 wherein the database stores the at least one personalized voice message added, at least in part, to the at least one designated part of the at least one music file in the remote media server and/or the physical storage location on the mobile communication device.

8. The system of claim 1 wherein the music files repository includes music files stored in the mobile communication device.

9. The system of claim 1 wherein the music repository includes music files selected from the remote media server, the remote media server is configured to communicate with the mobile application.

10. The system of claim 1 wherein the mobile application records the personalized voice message in the song and/or music file, the music file is selected based on mood, relationship and/or specialized events of the plurality of users.

11. The system of claim 1 wherein the mobile application enables playing the song and/or music file with the personalized voice message and shares through mail, messages and through any content sharing means.

12. A method of creating and distributing customized messages using a mobile communication device comprising:
launching a mobile application from the mobile communication device by a first user to access at least one music file from a music files repository;
adding at least one personalized voice message, at least in part, to the at least one designated part of the at least one music file, wherein the at least one personalized voice message being listed based on mood and/or relationship of a plurality of users and/or specialized events;
creating a customized message by the first user to distribute to a plurality of users, the customized message being suited to the mood, specialized events and/or relationship of the plurality of users;
storing the customized message created by the first user in a database and thereafter playing prior to distributing the customized message to the plurality of users, wherein the database resides in a remote media server and/or a physical storage location on the mobile communication device; and
sharing the customized message created by the first user to the plurality of users through a communication means.

13. The method of claim 12 wherein the mobile application installed in the mobile communication device access at least one music file from the music files repository based on a relationship with the plurality of users through a user interface.

14. The method of claim 12 wherein the customized message include a professionally recorded song by an artist, each of the professionally recorded songs includes at least 20 to 30 seconds background music section where the user records the at least one personalized voice message.

15. The method of claim 12 wherein the customized message include the professionally recorded song by artists agreeing to unlimited duplication of the professionally recorded songs for the purpose of exposure and/or advertising of own skills.

16. The method of claim 12 wherein the at least one personalized voice message can be added, at least in part, to a plurality of designated part of the background music of the professionally recorded song.

17. The method of claim 12 wherein the database resides in a physical storage location on the mobile communication device and/or the remote media server, the remote media server is in communication with a plurality of mobile communication devices of the plurality of users.

18. The method of claim 12 wherein the customized message having the at least one personalized voice message is send to the plurality of mobile communication devices of the plurality of users through the communication means over a network.

19. The method of claim 12 wherein the communication means includes Wi-Fi, Bluetooth, near field communication (NFC), infrared communication, electronic mail and messages.
